(19) United States
(12) Patent Application Publication
(10) Pub. No.: US 2007/0091981 A1
(43) Pub. Date: Apr. 26, 2007

(54) Reversible thermochromic optical disc

(76) Inventors: Chen Peng, Taipei City (TW); Fung-Hsu Wu, Gueishan Township (TW); Wai Wang, Taoyuan City (TW); Bow-Yi Jang, Taichung City (TW); Lin Hsiao, Taoyuan City (TW); Ta-Yuan Lee, Linkou Township (TW); Yao-Wen Chang, Fongshan City (TW)

Correspondence Address: HOFFMAN WARNICK & D'ALESSANDRO, LLC, 75 STATE STREET, 14TH FLOOR, ALBANY, NY, 12207, US

(21) Appl. No.: 11/418,198

(22) Filed: May 4, 2006

(30) Foreign Application Priority Data
Oct. 21, 2005 (TW) 094136801

(51) Int. Cl. G01K 11/00

(52) U.S. Cl. 374/162

(57) ABSTRACT

The present invention provides a reversible thermochromic optical disc capable of forming a pattern thereon by an optical pick-up unit of an optical disc drive. The reversible thermochromic optical disc includes a substrate and a reversible thermochromic dyestuff. The substrate has a label surface. The reversible thermochromic dyestuff coated on the label surface has a hysteresis characteristic upon change of a temperature, and changes between a colored state and a decolored state, wherein the color of the reversible thermochromic dyestuff responds to heat of a laser beam emitted by the optical pick-up unit to form the pattern.

### BACKGROUND OF THE INVENTION

1. Field of the Invention

The invention relates to a reversible thermochromic optical disc and, more particularly, to a reversible thermochromic optical disc or an optical disc capable of forming a pattern thereon by an optical pick-up unit of an optical disc drive.

2. Description of the Prior Art

Optical discs are a highly popular medium for storing data in various forms such as text, graphics, audio, video . . . etc. Examples of available optical disc formats including CD-R, CD-RW, DVD-R, DVD-RW . . . etc. When optical disc technology was first introduced, only source manufacturers could program optical discs, and they typically did so on a mass production basis. Once formatted with the desired data, the optical discs were provided to consumers with some form of printed identification information on a non-data surface thereof. More recently, consumers have been able to “burn” the data which they want onto a “blank” optical disc. Once formatted, the user will almost certainly desire to provide some form of identification information on the non-data surface of the optical disc. However, unlike the optical discs produced by manufacturers, the ones used by common users do not provide the means to print identification information thereon. Instead, users generally stick a label made of paper on the optical disc.

In recent years, there have been several proposed techniques related to creating patterns on the label layer of an optical disc, such as a technique proposed in 2005 by Hewlett-Packard Development Company, HP. The technique is known as the LightScribe technique, in which a coloring layer that changes its color in response to heat or light is provided by the label layer of the optical disc. The coloring layer is set to face an optical pickup, by which a laser beam is irradiated to cause the coloring layer to change its color, so as to form a visible pattern. Therefore, the optical disc can be identified through this technique.

However, the pattern formed by the LightScribe technique on the optical disc is permanent. In other words, when the pattern is not formed well or the content of the label is intended to be changed, the pattern formed by the LightScribe technique can not be erased or changed. With advancement of multi-segment burning technique, when a user hopes to change the pattern on the label surface of the optical disc, the LightScribe technique can not meet this requirement.

Therefore, the present invention provides a reversible thermochromic optical disc coated with a reversible thermochromic dyestuff thereon. The reversible thermochromic optical disc allows an optical pick-up unit of an optical disc drive to form or alter the patterns thereon, so that a user can easily and repeatedly change the label on the optical disc.

### SUMMARY OF THE INVENTION

The invention is to provide a reversible thermochromic optical disc and, more particularly, a reversible thermochromic optical disc capable of forming a pattern thereon and repeatedly changing the pattern by an optical pick-up unit of an optical disc drive. According to a first preferred embodiment of the invention, the reversible thermochromic optical disc includes a substrate and a reversible thermochromic dyestuff. The substrate has a label surface. The reversible thermochromic dyestuff coated on the label surface has a characteristic of hysteresis upon change of temperature, and it changes between a colored state and a decolored state, wherein the color of the reversible thermochromic dyestuff responds to the heat of a laser beam emitted by the optical pick-up unit to form the pattern. After heated or cooled in order to change color, the reversible thermochromic dyestuff can retain its reversibility and color in normal temperature.

The invention provides a reversible thermochromic optical disc coated with a reversible thermochromic dyestuff on the label surface. The dyestuff has the property of changing its color state in accordance with the temperature together with a hysteresis characteristic. Thus, the objective of changing pattern is achieved by the heat of a laser beam emitted by the optical pick-up unit of the optical disc drive. Besides, the stability of the reversible thermochromic dyestuff can be increased, plus lifespan can be extended by using microcapsules to encapsulate the dyestuff and to effectively control the diffusion of the dyestuff.

The advantage and spirit of the invention may be understood by the following recitations together with the appended drawings.

### BRIEF DESCRIPTION OF THE APPENDED DRAWINGS

FIG. 1 illustrates the relationship between the temperature and the color density of a reversible thermochromic dyestuff and explains the hysteresis characteristic belonging to the reversible thermochromic dyestuff of the invention.

### DETAILED DESCRIPTION OF THE INVENTION

The invention is to provide a reversible thermochromic optical disc capable of forming a pattern thereon by an optical pick-up unit of an optical disc drive. The reversible thermochromic optical disc includes a substrate and a reversible thermochromic dyestuff. The substrate has a label surface. The reversible thermochromic dyestuff coated on the label surface has a hysteresis characteristic upon change of temperature, and changes between a colored state and a decolored state, wherein the color of the reversible thermochromic dyestuff responds to the heat of a laser beam emitted by the optical pick-up unit to form the pattern.

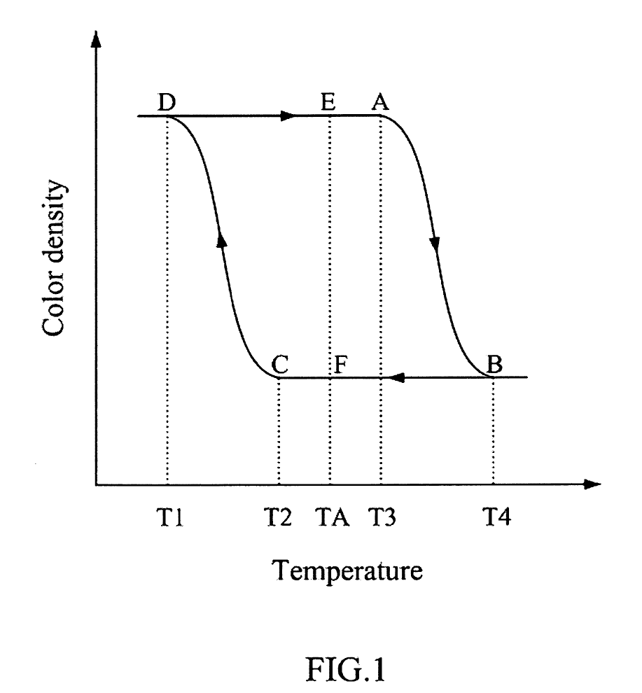

Referring to FIG. 1, FIG. 1 illustrates the relationship between the temperature and the color density of a reversible thermochromic dyestuff and explains the hysteresis characteristic belonging to the reversible thermochromic dyestuff of the invention. The vertical coordinate in FIG. 1 represents the color density of the reversible thermochromic dyestuff, and the horizontal coordinate represents the temperature. The color density of the reversible thermochromic dyestuff changes along the direction directed by the arrow marks on the temperature curve.

Point A represents the highest temperature, i.e. temperature T3 in FIG. 1, at which the reversible thermochromic dyestuff still remains in completely colored state. Thus, temperature T3 is called the maximum colored temperature. Point B shows that the reversible thermochromic dyestuff reaches completely decolored state when its color density corresponds to temperature T4 in FIG. 1, which is called the completely decolored temperature. Point C represents the lowest temperature, i.e. temperature T2 in FIG. 1, at which the reversible thermochromic dyestuff remains in completely decolored state. Thus, temperature T2 is called the minimum colored temperature. Point D shows that the reversible thermochromic dyestuff reaches completely colored state when its color density corresponds to temperature T1 in FIG. 1, which is called the completely colored temperature. At temperature TA in FIG. 1, the reversible thermochromic dyestuff may be in colored state (point E) or the decolored state (point F).

The hysteresis characteristic shows that when the reversible thermochromic dyestuff is in the colored state, the temperature has to rise to temperature T3 for the color density of the dyestuff to decrease gradually. Then, the reversible thermochromic dyestuff will be transferred into completely decolored state when the temperature rises to temperature T4. In the same manner, when the reversible thermochromic dyestuff is in decolored state, the temperature has to decrease to temperature T2 for the color density of the dyestuff to increase gradually. Then, the reversible thermochromic dyestuff will be transferred into completely colored state when the temperature decreases to temperature T1. Therefore, when the temperature changes in the range of critical temperature, i.e., a common temperature, the reversible thermochromic dyestuff will not change its color density. In other words, the dyestuff retains its color state rather than change its state with the temperature within this range.

There are many kinds of reversible thermochromic dyestuff having a hysteresis characteristic and can be adapted to the invention, wherein the ingredients of a reversible thermochromic dyestuff disclosed in U.S. Pat. No. 5,558,699 are adapted to a reversible thermochromic optical disc of the invention. The reversible thermochromic dyestuff disclosed in U.S. Pat. No. 5,558,699 changes between a colored state and a decolored state and has a hysteresis characteristic upon change of temperature. Furthermore, since the reversible thermochromic dyestuff has a wide hysteresis range, it does not change its state in the common temperature and is adapted to the reversible thermochromic optical disc of the invention.

U.S. Pat. No. 5,558,699 discloses a reversible thermochromic dyestuff including a homogeneous soluble compound consisting of three essential ingredients. These three ingredients are as follows: (a) an electron-donating color-developing organic compound, (b) an electron-accepting compound, and (c) a reaction medium. Referring to U.S. Pat. No. 5,558,699, the detailed chemical ingredients are recited in it.

In an embodiment of the invention, the reversible thermochromic dyestuff is encapsulated by a plurality of microcapsules which are coated on the label surface of the reversible thermochromic optical disc. A microcapsule is powdery in the size from 6 to 10 micrometers. When the reversible thermochromic dyestuff is encapsulated by microcapsules, it is not easily influenced by environment. Therefore, the reversible thermochromic dyestuff effectively extends its efficacy and is prevented from oxidizing and changing its color; its stability is also increased. Besides, the exterior membrane of the microcapsule can adjust diffusion of what is encapsulated, allowing the reversible thermochromic dyestuff to be gradually diffused as time elapses. Therefore, the exterior membrane can extend the lifespan of the dyestuff.

A mixture is homogenously coated on the label surface when the reversible thermochromic dyestuff is coated on the label surface of the substrate of the reversible thermochromic disc in the form of microcapsules. The mixture includes a pigment for exhibiting the color, a medium for controlling the reaction of the color, a dispersant for homogenously distributing the plurality of microcapsules in the medium, and an emulsifier for dissolving the plurality of microcapsules in the medium.

In an embodiment of the invention, the reversible thermochromic dyestuff coheres in powdery form. When the reversible thermochromic dyestuff is coated on the label surface of the reversible thermochromic optical disc, a mixture is also coated on the label surface. The mixture includes a pigment for exhibiting the color, a medium for controlling the reaction of the color, a dispersant for homogenously distributing the powdery reversible thermochromic dyestuff, and an emulsifier for dissolving the powdery reversible thermochromic dyestuff in the medium.

In an embodiment of the invention, a plurality of marks is formed on the label surface of the reversible thermochromic optical disc for assisting the optical pick-up unit to register with respect to the label surface.

In an embodiment of the invention, the reversible thermochromic dyestuff is coated on the label surface by a screen printing process.

The invention provides a reversible thermochromic optical disc coated with a reversible thermochromic dyestuff on the label surface. The dyestuff has a hysteresis characteristic upon change of temperature, so as to change its color state in accordance with the temperature. Thus, the reversible thermochromic optical disc is capable of showing and changing patterns by the heat of a laser beam emitted by the optical pick-up unit of the optical disc drive. Since the reversible thermochromic dyestuff has a hysteresis characteristic, the pattern is not changed in common temperature, so that a user can easily and repeatedly change the pattern on the label surface.

In addition, the stability of the reversible thermochromic dyestuff can be increased and its lifespan can be extended, by using microcapsules to encapsulate the dyestuff and to effectively control the diffusion of the dyestuff. Therefore, the pattern on the label surface can be retained for a long time. Furthermore, the reversible thermochromic dyestuff also can be an indicator of expiration date since the microcapsule controls the gradual diffusion of the dyestuff as time elapses. When the reversible thermochromic dyestuff is completely diffused, so that the pattern on the optical disc can not be changed anymore, the reversible thermochromic optical disc reaches the expiration date.

With the recitations of embodiment above, the features and spirits of the invention will be hopefully well described. However, the scope of the invention is not restricted by the preferred embodiment disclosed above. The objective is that all alternative and equivalent arrangements are hopefully covered in the scope of the appended claims of the invention.

What is claimed is:

1. A reversible thermochromic optical disc capable of forming a pattern thereon by an optical pick-up unit of an optical disc drive, said reversible thermochromic optical disc comprising:
a substrate having a label surface; and
a reversible thermochromic dyestuff, coated on the label surface, having a color with hysteresis characteristic upon change of a temperature, and changing between a colored state and a decolored state, wherein the color of the reversible thermochromic dyestuff responds to heat of a laser beam emitted by the optical pick-up unit to form the pattern.

2. The reversible thermochromic optical disc of claim 1, wherein the reversible thermochromic dyestuff is encapsulated by a plurality of microcapsules which are coated on the label surface.

3. The reversible thermochromic optical disc of claim 2, further comprising a mixture homogenously coated on the label surface, said mixture comprising:
a pigment for exhibiting the color;
a medium for controlling reaction of the color;
a dispersant making the plurality of microcapsules disperse homogenously in the medium; and
an emulsifier making the plurality of microcapsules dissolve in the medium.

4. The reversible thermochromic optical disc of claim 1, wherein the reversible thermochromic dyestuff is powdery.

5. The reversible thermochromic optical disc of claim 4, further comprising a mixture coated on the label surface, said mixture comprising:
a pigment for exhibiting the color;
a medium for controlling reaction of the color;
a dispersant making the powdery reversible thermochromic dyestuff disperse homogenously in the medium; and
an emulsifier making the powdery reversible thermochromic dyestuff dissolve in the medium.

6. The reversible thermochromic optical disc of claim 1, wherein a plurality of marks are formed on the label surface for assisting the optical pick-up unit to register with respect to the label surface.

7. The reversible thermochromic optical disc of claim 1, wherein the reversible thermochromic dyestuff is coated on the label surface by a screen printing process.
